(19) United States
(12) Patent Application Publication
(10) Pub. No.: US 2015/0086321 A1
(43) Pub. Date: Mar. 26, 2015

(54) METHOD FOR LIFTING A CONCRETE PRODUCT WITH A LIFTING BOOM AND LIFTING BOOM

(71) Applicant: Elematic Oy Ab, Akaa (FI)

(72) Inventors: Pekka KORKIAMAKI, Toijala (FI); Leena RAUKOLA, Kangasala (FI); Jani EILOLA, Lempaala (FI)

(73) Assignee: ELEMATIC OY AB, Akaa (FI)

(21) Appl. No.: 14/490,865

(22) Filed: Sep. 19, 2014

(30) Foreign Application Priority Data
Sep. 20, 2013 (FI) 20135942

(51) Int. Cl. E04G 21/16; B66C 1/66

(52) U.S. Cl. CPC E04G 21/167; B66C 1/666
USPC 414/800; 294/81.2

(57) ABSTRACT

Method for lifting a concrete product with a lifting boom and a lifting boom, in which method the lifting boom is moved above the concrete product to be lifted with a crane, lifting hooks of the lifting boom are set in lifting loops located in the concrete product to be lifted, and the lifting is carried out by lifting the lifting boom together with the concrete product with a crane, wherein the location of at least one lifting loop in the concrete product to be lifted is detected by a control system of the lifting boom, which control systems moves at least one lifting hook along the lifting boom to the location of the lifting loop.

This application claims benefit of Fl 20135942, filed 20 Sep. 2013, the entire contents of which are incorporated herein by reference for all purposes.

### BACKGROUND

1. Field

The present disclosure relates to lifting of concrete products with a lifting boom. More precisely the invention relates to a method for lifting a concrete product with a lifting boom, where the concrete product to be lifted is connected to the lifting hooks of the lifting boom via lifting loops of the concrete product. The disclosure also relates to a lifting boom having at least two lifting hooks.

2. Description of Related Art

Concrete wall elements are generally lifted through lifting loops located at the top surface of the element. The locations of the lifting loops in the elements allow storing of the elements in vertical orientation for minimizing the space required for storage and make the installation of the wall elements easier in the construction site. The lifting of the wall elements is generally carried out with lifting hooks that are set in the lifting loops of the element, which lifting hooks are connected to a lifting boom with chains. The locations of chains and hooks in relation to the lifting boom can usually be adjusted to be suitable for different widths of wall elements and thus for different locations of the lifting loops.

When the wall elements are to be lifted, especially in storage, the adjustment of chains and lifting hooks in relation to the lifting boom and setting the lifting hooks in the lifting loops of the wall elements are normally carried out manually. Especially the setting of lifting hooks generally requires person to climb on top of the wall element. This creates problems for work safety since the height of the wall elements can be up to three meters or more. Further, this climbing on top of the wall element and setting of the lifting hooks in the lifting loops is also time consuming procedure.

### SUMMARY

In order to overcome the above mentioned drawbacks, a new method for lifting a concrete product with a lifting boom and a lifting boom are now provided.

In an embodiment of the method of the invention a lifting boom is first moved above the concrete product to be lifted, then an automatic control system of the lifting boom is activated, which control system first or simultaneously detects the location of at least one lifting loop in the concrete element to be lifted and moves at least one lifting hook of the lifting boom along the lifting boom to the location of the lifting loop. After the lifting hooks are positioned above the lifting loops, the lifting hooks are attached to the lifting loops of the product to be lifted, which may include manual or partly manual steps or may be completely carried out automatically with the automatic control system.

In an embodiment of the method of the present invention the control system advantageously moves a pair of lifting hooks simultaneously equal distances along the lifting boom at opposite directions, so that the lifting hooks are equal distance from the center of the lifting boom, which is required for balanced lifting of the concrete product with the lifting boom.

In an embodiment of the method of the invention the control system of the lifting boom may advantageously either also control the crane lifting and moving the lifting boom, or indicate the person operating the crane to which relation the lifting boom is to be moved, so that after the location of a first lifting loop of the concrete product to be lifted is detected, the whole lifting boom in relation to the concrete product to be lifted may be moved for properly detecting the location or locations of a second or more lifting loops. This allows the adjustment of the lifting boom in relation to the product to be lifted in cases where the placement of the lifting boom in relation to the concrete product to be lifted was not originally correct, or the placement of the lifting loops in the concrete product is not symmetrical.

In an embodiment of the method of the present invention the attachment of the lifting hooks to the lifting loops of the concrete product to be lifted is advantageously achieved with vertical movement of the lifting hooks in relation to the lifting boom, which vertical movement is controlled by the control system. Further, the lifting hooks are advantageously configured so, that once the downward vertical movement of the lifting hooks has proceeded in the area of the lifting loop, the lifting hooks automatically lock themselves to the lifting loops. Alternatively the vertical downward movement of the lifting hooks may be achieved by moving the whole lifting boom downwards.

In an embodiment of the method of the present invention the detachment of the lifting hooks from the lifting loops of the concrete product is advantageously achieved with the control system after the lifting of the concrete product is done. This detachment may be achieved with suitable vertical movement of the lifting hook(s) or by releasing a member causing the locking, for example.

The attachment and detachment processes may be aided with suitable sensors defining the distance of the lifting hooks from the surface of the concrete product, as well as with sensors defining open and closed/locked position of the lifting hooks themselves.

The method of embodiments of the present invention is not restricted to the use of a single lifting boom, but it may advantageously also be used with a lifting equipment comprising two or more lifting booms connected to each other with a connecting beam extending in perpendicular horizontal direction in relation to the length of the lifting booms. Alternatively the lifting hooks may also be movable in perpendicular horizontal direction, in addition to the mentioned vertical direction, in relation to the length of the lifting boom in case of a single lifting boom device.

The lifting boom of an embodiment of the present invention, which is configured to be connected to a hook of a crane and comprises at least two lifting hooks, also comprises means for detecting location of at least one lifting loop in the concrete product to be lifted, means for moving at least one lifting hook along the lifting boom, and an automatic control system for controlling these means.

With the control system of the lifting boom of the invention the location of the lifting loops in the concrete product may be defined by locating even a single lifting loop in the concrete product, with the help of design information of the concrete product or with properly placing and centering the lifting boom above the concrete product, for example.

The means for detecting the location of at least one lifting loop of the concrete product, or all lifting loops located in the concrete product, may advantageously be implemented with computer vision cameras, distance sensors, RFID-tag detectors reacting to the RFID tags attached to the lifting loops, induction sensors, or with other suitable sensors, for example.

The means for moving the lifting hook along the lifting boom may advantageously comprise a sledge for each lifting hook, which sledge is connected movably to the lifting boom, into which sledge lifting hook is connected vertically adjustably, and a hydraulic or electric motor for moving a pair of the sledges simultaneously in opposite directions along the boom.

In the lifting boom of the invention the lifting hooks advantageously comprises two hook-shaped parts, which parts are configured to attach themselves to the lifting loop from opposite sides of the lifting loop. This embodiment provides secure attachment of the lifting loop to the lifting hook.

The lifting boom according to the invention may also comprise suitable sensors for defining the distance of the lifting hooks from the surface of the concrete product, as well as sensors for defining open and closed/locked position of the lifting hooks themselves.

The lifting boom of an embodiment of the invention may advantageously also be part of a lifting equipment comprising two or more lifting booms, which lifting booms are connected to each other with suitable connecting beam extending substantially horizontally between the lifting booms advantageously perpendicularly in relation to the length of the lifting booms, into which connecting beam the lifting booms are connected movably. This embodiment allows lifting of a concrete product in horizontal orientation, such as hollow core and massive slabs, for example.

The lifting boom of an embodiment of the invention may also advantageously comprise means for controlling the crane lifting and moving the lifting boom, or means for indicating the direction to which the lifting boom is to be moved in relation to the concrete product to be lifted. Thus the lifting boom may be properly centered over two or more lifting loops located in the concrete product to be lifted.

The feature defining a method of an embodiment of the present invention are more precisely presented as a method for lifting a concrete product with a lifting boom (1), in which method the lifting boom is moved above the concrete product to be lifted with a crane, lifting hooks (8, 8′) of the lifting boom are set in lifting loops located in the concrete product to be lifted, and the lifting is carried out by lifting the lifting boom together with the concrete product with a crane, characterized in that the location of at least one lifting loop in the concrete product to be lifted is detected by a control system (15) of the lifting boom (1), which control systems moves at least one lifting hook (8, 8′) along the lifting boom to the location of the lifting loop

The features defining a lifting boom of an embodiment of the present invention are more precisely presented as a lifting boom (1) for lifting a concrete product, which lifting boom is configured to be connected to a hook of a crane, and which lifting boom comprises at least two lifting hooks (8, 8′), characterized in that the lifting boom (1) comprises means (16) for detecting a location of at least one lifting loop in the concrete product to be lifted, means (9, 9′, 11, 11′, 12, 13, 14, 14′) for moving at least one lifting hook (8, 8′) along the lifting boom, and a control system (15) for controlling these means.

Other features include:

embodiments wherein the control system (15) moves the lifting hooks (8, 8′) simultaneously and same distance from the center of the lifting boom (1) in opposite directions on the basis of the detected location of the at least one lifting loop,

embodiments wherein the control system (15) moves the lifting boom (1) in relation to the concrete product to be lifted, or indicates the direction to which the lifting boom is to be moved, after detecting the location of a first lifting loop in order to detect the location of a second lifting loop and to place the lifting hooks (8, 8′) above the said lifting loops,

embodiments wherein vertical positions of the lifting hooks (8, 8′) in relation to the lifting boom (1) are adjusted by the control system (15),

embodiments wherein the setting of the lifting hooks (8, 8′) to the lifting loops locks the lifting hooks to the lifting loops,

embodiments wherein the control system (15) detaches the lifting hooks (8, 8′) from the lifting loops after the lifting of the concrete product is done,

embodiments wherein perpendicular horizontal distance between the lifting hooks and the length of the lifting boom (1) is controlled by the control system (15),

embodiments wherein the means (16) for detecting the location of at least one lifting loop comprises a computer vision camera, a distance sensor, a RFID-tag detector and/or an induction sensor,

embodiments wherein the means for moving the lifting hooks along the lifting boom comprises a sledge (9, 9′) for each lifting hook (8, 8′), which sledge is connected movably to the lifting boom, into which sledge lifting hook is connected vertically adjustably, and a hydraulic or electric motor (12) for moving a pair of the sledges simultaneously in opposite directions along the boom,

embodiments wherein the lifting hook (8, 8′) comprises two hook-shaped parts (21, 21′), which parts which are configured to attach themselves to the lifting loop from opposite sides of the lifting loop,

embodiments wherein two or more lifting booms are connected to each other with a connecting beam extending substantially horizontally between the lifting booms, into which connecting beam the lifting booms are connected movably, and

embodiments wherein the control system (12) of the lifting boom comprises means for controlling the crane lifting and moving the lifting boom, or means for indicating the direction to which the lifting boom is to be moved.

### BRIEF DESCRIPTION OF DRAWINGS

Exemplifying embodiments of the invention and their advantages are explained in greater detail below in the sense of example and with reference to accompanying drawings, where

FIGS. 1A and 1B show schematically a lifting boom according to an embodiment of the invention in two different positions, and

FIGS. 2A and 2B show schematically an embodiment of a lifting hook arrangement for a lifting boom of the invention in two different positions.

### DETAILED DESCRIPTION OF SPECIFIC EMBODIMENTS

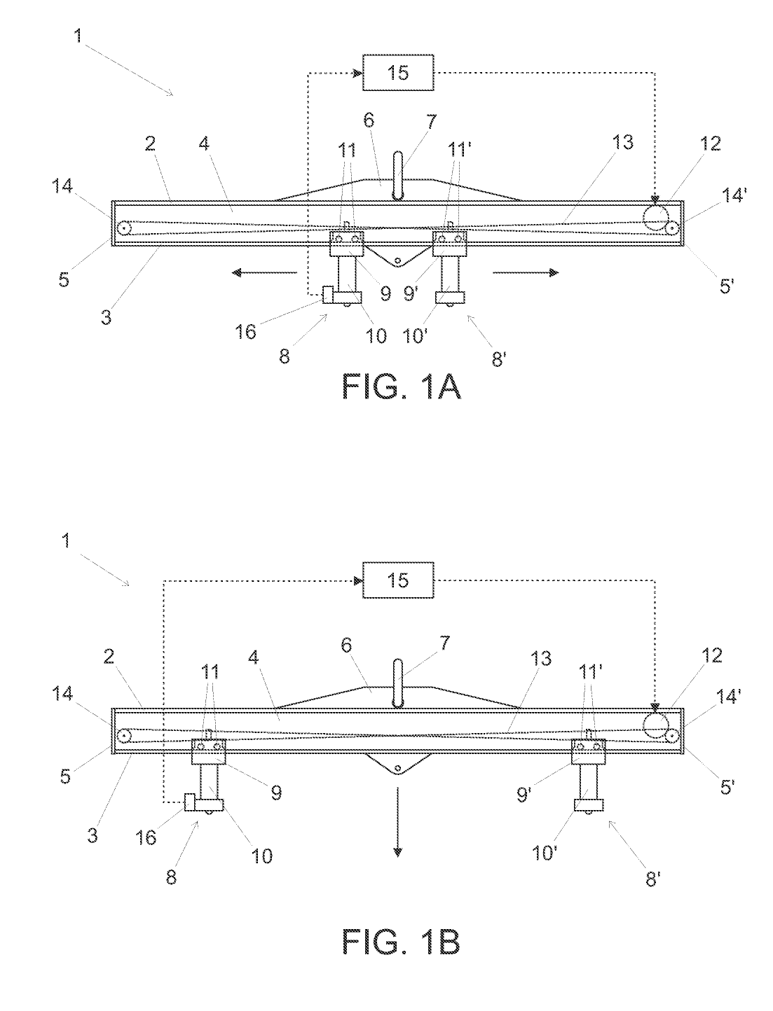

The lifting boom 1 shown schematically in FIGS. 1A and 1B is formed from a steel I-beam comprising horizontal upper flange 2 and lower flange 3, which flanges are connected with web portion 4. At the ends of the I-beam are welded plates 5, 5′ which cover the width of the flanges 2, 3 and extend vertically from the upper flange to the lower flange.

On the top surface of the upper flange 2, substantially in the same plane as the web portion 4, is welded vertically extending plate 6, which comprises a hole through which hole a steel loop 7 is fitted for lifting the lifting boom 1. The loop 7 for lifting the lifting boom 1 is located at the center area of the lifting boom so that the lifting boom may maintain its substantially horizontal position during lifting of the lifting boom.

At the lower part of the lifting boom 1, on the lower flange 3 are mounted movably two lifting hook units 8, 8′, which lifting hook units comprises sledge parts 9, 9′ and lifting hook parts 10, 10′ extending downwards from the lower surface of the sledge parts.

The sledge parts 9, 9′ extend partially around the lower flange 3 so that the edges of the sledge parts are above and on top of the lower flange. Top portions of the sledge parts 9, 9′ are equipped with wheels 11, 11′ that set on the top surface of the lower flange 3, which wheels allow the sledge parts to slide along the lower flange. The wheels 11, 11′ are advantageously mounted in the sledge parts 9, 9′ so, that when the weight of the lifted concrete element is conveyed to the sledge parts, the wheels yield suitably so, that the wheels don't carry the weight but suitable fixed support structures in sledge parts 9, 9′ will set themselves against the top surface of the lower flange 3 due to this yielding of wheels and the weight of the concrete product is thus conveyed directly from the sledge parts to the lower flange 3 of the lifting boom.

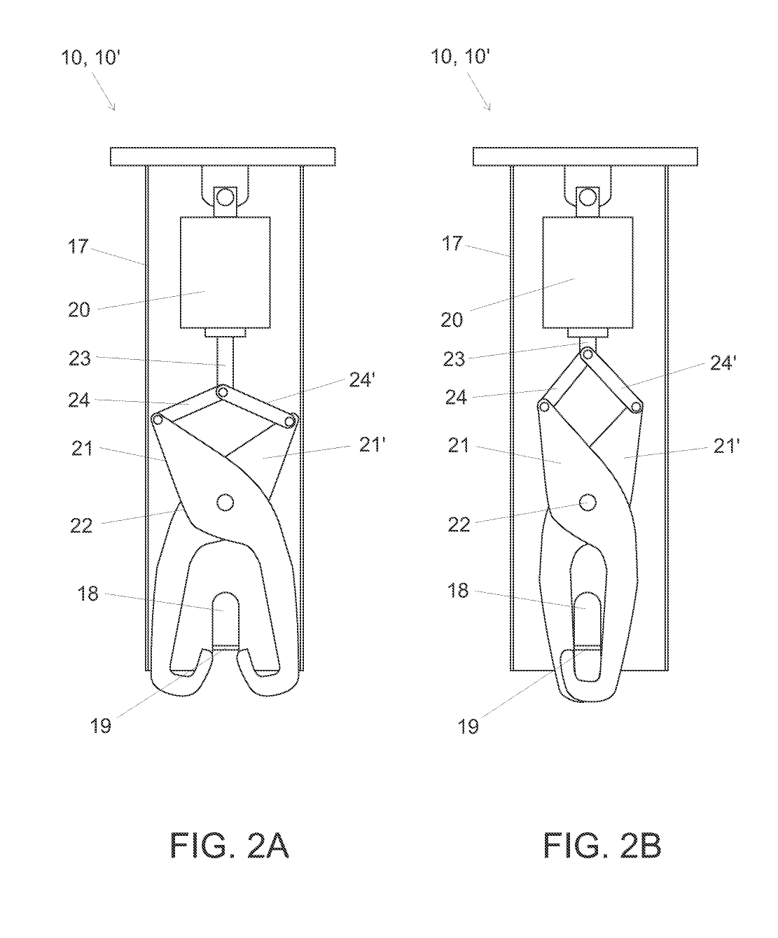

Example of a suitable hook parts 10, 10′ and their configurations are discussed in more detail later in the discussion relating to FIGS. 2A and 2B.

The sledge parts 9, 9′, and thus the whole lifting hook units 8, 8′, are moved along the lower flange 3 with an electrical motor 12 via a chain 13, which goes around chain gears 14, 14′ located at the end areas of the web portion 4. The configuration of the chain 13 and the fixing of the sledge parts 9, 9′ to the chain are implemented so that when the chain is moved, the sledge parts move in opposite directions in relation to each other along the lower flange 3.

The lifting boom 1 also comprises an automatic control system 15, which collects information from sensor 16 fixed at least to one of the lifting hook units 8, 8′, which sensor can be for example a computer vision camera or a suitable distance sensor, and operates the electric motor 12 for moving the lifting hook units 8, 8′ along the lower flange 3.

When the lifting boom 1 is used for lifting a concrete product, the lifting boom in first moved above the proper surface of the concrete product to be lifted with a crane on which surface the lifting loops are located, such as the upper surface of a wall element. The lifting boom 1 is also aligned to substantially the same direction with the said surface and centered in relation to the said surface.

Once the lifting boom 1 is properly positioned, the automatic control system 15 is activated, either manually or automatically. Once the control system 15 is activated, in the situation shown in FIG. 1A, the control system starts to move the lifting hook units 8, 8′ from the center area of the lifting boom 1 towards the end areas of the lifting boom as shown by the arrows in FIG. 1, by controlling the electric motor 12. During this movement, the control system 15 follows the information provided by the sensor 16.

Once the control system 15 receives information from the sensor 16 that the sensor has detected a lifting loop, the control system either stops movement of the lifting hook units 8, 8′, or continues the movement of the lifting hook units in order to center these units properly over the lifting loops of the product to be lifted.

Alternatively or in addition, one or more sensors 16 may also be located in the I-beam part of the lifting boom 1, so that the location of the lifting loops in the concrete product may be defined by the control system 15 before the moving of the lifting hook units 8, 8′ is started, for example.

Further, in embodiments where both of the lifting hook units 8, 8′ are equipped with their own sensors 16 for detecting the location of the lifting loop in the concrete product, once one of the lifting hook units detects the location of a first lifting loop, the lifting boom 1 may be moved away from the detected location of the first lifting loop and simultaneously the lifting hook units 8, 8′ are moved away from each other. In this way the first lifting hook unit maintains its position above the first lifting loop and the second lifting hook unit can proceed much faster to identify the location of the second lifting loop and to position itself above it. This embodiment also allows repositioning of the lifting boom 1 in relation to the concrete product to be lifted when necessary. This type of repositioning process of the lifting boom 1 may be implemented either by allowing the automatic control system 15 to also control the crane lifting and moving the lifting boom, or by equipping the automatic control system with suitable means or indicator that indicates to the operator of the crane the directions to which the crane is to be moved.

Once the lifting hook units 8, 8′ are properly placed over the lifting loops, the control system 15 either informs the user of the crane of the proper placement, or controls the control system of the crane on which hook the lifting boom 1 is attached, for lowering the lifting boom, as shown with an arrow in FIG. 1 B, so that the lifting hooks of the lifting hook units 8, 8′ can attach themselves on the lifting loops of the concrete product to be lifted.

The attachment and detachment of the hooks of the lifting hook units 8, 8′ are also advantageously controlled by the control unit 15. The attachment and detachment processes may be aided with suitable sensors defining the distance of the lifting hook units 8, 8′ from the surface of the concrete product, as well as with sensors defining open and closed/locked position of the lifting hooks themselves.

FIGS. 2A and 2B show schematically an embodiment for lifting hook parts 10, 10′, which comprises casing 17 shown in cross-section so that parts inside the casing are more readily visible, which casing has an open bottom surface. The casing 17 comprises recesses 18 formed in the bottom part of the casing, as well as rods 19, for guiding the lifting hook unit 8 in two perpendicular directions properly on the lifting loop of the product to be lifted. Inside the casing 17, attached to the top surface is a linear actuator 20, such as a linear motor or hydraulic cylinder. At the lower portion of the casing 17 is connected hook parts 21, 21′ forming the actual lifting hook, which hook parts are connected to each other and to the walls of the casing rotatably with a fixing rod 22. Upper ends of the hook parts 21, 21′ are connected to a linearly movable shaft 23 of the linear actuator 20 via levers 24, 24′.

FIG. 2A shows the position of the lifting hook parts 10, 10′ in which the lifting hook parts can be lowered on a lifting loop of a concrete product to be lifted. In this position the shaft 23 of the linear actuator 20 is moved to its outermost position, which moves the upper ends of the hook parts 21, 21′ away from each other and causes the lower ends of the hook parts also move away from each other so that the lifting loop of the concrete product to be lifted can fit on the area between the lower ends of the hook parts.

Once the lifting loop of the concrete product to be lifted is located in the recess 18 of the casing 17 and between the lower ends of the hook parts 21, 21′, the shaft 23 of the linear actuator 20 is moved to its innermost position, which moves lower ends of the hook parts towards each other and in partially overlapping position shown in FIG. 2B. In this position the lifting loop is securely locked to the lifting hook part 10, 10′, and the lifting of the concrete product can be started.

In the above discussed embodiments the vertical movement of the lifting hook units and parts is achieved by vertically moving the whole lifting boom with a separate crane. This vertical movement can also achieved by connecting the lifting hooks or lifting hook units or parts vertically adjustably to the lifting boom, so that when attaching the lifting hooks or lifting hook units to the lifting loops only the hooks or hook units are moved in vertical direction and not the whole lifting boom. This type of vertically adjustable connection between the beam part and the lifting hook or lifting hook unit is known to a person skilled in the art, and there are several different types of known construction forms implementing this.

In relation to the embodiments shown in the figures and discussed above it is to be noted that these embodiments are only examples which can be modify in many ways evident to a person skilled in the art. Thus the scope of the invention is not restricted to the presented embodiments but only to the scope of the attached claims.

1. A method for lifting a concrete product with a lifting boom, comprising:
moving the lifting boom above the concrete product to be lifted with a crane,
setting lifting hooks of the lifting boom in lifting loops located in the concrete product to be lifted, and
carrying out the lifting by lifting the lifting boom together with the concrete product with a crane,
wherein the location of at least one lifting loop in the concrete product to be lifted is detected by a control system of the lifting boom, which control system moves at least one lifting hook along the lifting boom to the location of the lifting loop.

2. The method according to claim 1, wherein the control system moves the lifting hooks simultaneously the same distance from a center of the lifting boom in opposite directions on the basis of the detected location of the at least one lifting loop.

3. The method according to claim 1, wherein the control system moves the lifting boom in relation to the concrete product to be lifted, or indicates the direction to which the lifting boom is to be moved, after detecting the location of a first lifting loop in order to detect the location of a second lifting loop and to place the lifting hooks above the lifting loops.

4. The method according to claim 1, wherein vertical positions of the lifting hooks in relation to the lifting boom are adjusted by the control system.

5. The method according to claim 1, wherein the setting of the lifting hooks to the lifting loops locks the lifting hooks to the lifting loops.

6. The method according to claim 1, wherein the control system detaches the lifting hooks from the lifting loops after the lifting of the concrete product is done.

7. The method according to claim 1, wherein a perpendicular horizontal distance between the lifting hooks and the length of the lifting boom is controlled by the control system.

8. A lifting boom for lifting a concrete product, which lifting boom is configured to be connected to a hook of a crane, and comprising:
at least two lifting hooks,
means for detecting a location of at least one lifting loop in the concrete product to be lifted,
means for moving at least one lifting hook along the lifting boom, and
a control system for controlling these means.

9. The lifting boom according to claim 8, wherein the means for detecting a location of at least one lifting loop comprises a computer vision camera, a distance sensor, a RFID-tag detector and/or an induction sensor.

10. The lifting boom according to claim 8, wherein the means for moving at least one lifting hook along the lifting boom comprises a sledge for each lifting hook, which sledge is connected movably to the lifting boom, into which sledge a lifting hook is connected vertically adjustably, and a hydraulic or electric motor for moving a pair of the sledges simultaneously in opposite directions along the boom.

11. The lifting boom according to claim 8, wherein the lifting hook comprises two hook-shaped parts, which parts which are configured to attach themselves to the lifting loop from opposite sides of the lifting loop.

12. The lifting boom according to claim 8, wherein two or more lifting booms are connected to each other with a connecting beam extending substantially horizontally between the lifting booms, into which connecting beam the lifting booms are connected movably.

13. The lifting boom according to claim 8, wherein the control system of the lifting boom comprises means for controlling the crane lifting and moving the lifting boom, or means for indicating the direction to which the lifting boom is to be moved.
